(19) United States
(12) Patent Application Publication
(10) Pub. No.: US 2024/0130500 A1
(43) Pub. Date: Apr. 25, 2024

(54) BAG WITH SECURITY SYSTEM AND OTHER ELEMENTS USEFUL FOR THE USER

(71) Applicant: AKEDJ FASHION INC., Vancouver (CA)

(72) Inventor: Audrey OBAME BINDANG, Vancouver (CA)

(21) Appl. No.: 18/469,100

(22) Filed: Sep. 17, 2023

Related U.S. Application Data
(60) Provisional application No. 63/380,247, filed on Oct. 20, 2022.

(51) Int. Cl. A45C 13/24; A45F 3/04; G01S 19/16; G06F 21/32

(52) U.S. Cl. CPC A45C 13/24; A45F 3/04; G01S 19/16; G06F 21/32; A45F 2003/001

(57) ABSTRACT

There is provided a bag having a security system comprising a locking system, an alarm system, and a positioning locator. The security system is configured for a remote operation from a system, computer, or smart phone. The locking system may comprise a voice identification system and/or a finger identification system. The alarm system may comprise a first mode configured for speaking and a second mode configured for using a camera.

### FIELD OF THE INVENTION

The present invention relates generally to bags. More specifically, the invention relates to a bag with an integrated security system comprising a locking system, an alarm system, and a digital locator. The bag according to the invention also comprises elements useful for the wellbeing and comport of the user.

### BACKGROUND OF THE INVENTION

When a person ventures outside the home and carries a bag with them, usually the bag includes items that are important to the person. Unfortunately, bag get lost and for various reasons. For example, bags may get stolen or simply the owner of a bag may misplace it and is unable to remember its location.

Bags with security systems are known in the art.

There is still a need for bags with more efficient, easy to use, and cost-effective security systems. Also, there is a need for bags which may allow users to perform other useful functions.

### SUMMARY OF THE INVENTION

The inventor has designed and constructed a bag which integrates a security system and other elements allowing for its efficient and convenient use. The bag also comprises elements that are useful for the wellbeing and comfort of the user.

In embodiments of the invention, the bag comprises a locking system, an alarm system, and a positioning locator, the security system being configured for a remote operation from a system, computer, or smart phone.

In embodiments of the invention, the locking system comprises a voice identification system and/or a finger identification system.

In embodiments of the invention, the alarm system comprises a first mode configured for speaking and a second mode configured for using a camera.

In embodiments of the invention, the positioning locator comprises a locator chip and/or a GPS tracking system.

In embodiments of the invention, the bag further comprises push notifications. In other embodiments, the bag further comprises a USB port, a battery power bank, and massage elements for massaging the shoulders and back of the user.

According to an aspect, the invention provides for a security system for a bag. The security system comprises a locking system, an alarm system, and a positioning locator, the security system being configured for a remote operation from a system, computer, or smart phone.

The invention thus provides the following in accordance with aspects thereof:
(1). A bag having a security system comprising a locking system, an alarm system, and a positioning locator, wherein the security system is configured for a remote operation from a system, computer, or smart phone.
(2). The bag according to (1) above, wherein the locking system comprises a voice identification system and/or a finger identification system.
(3). The bag according to (1) or (2) above, wherein the finger identification system is a one-, two-, three-, four-, or five-finger identification system.
(4). The bag according to any one of (1) to (3) above, wherein the alarm system comprises a first mode configured for speaking and a second mode configured for using a camera.
(5). The bag according to (4) above, wherein the first and second modes of the alarm system are configured for operation simultaneously or separately.
(6). The bag according to (4) or (5) above, wherein the camera is a live stream camera.
(7). The bag according to any one of (1) to (6) above, wherein the positioning locator comprises a locator chip and/or a GPS tracking system.
(8). The bag according to any one of (1) to (7) above, further comprising push notifications.
(9). The bag according to any one of (1) to (8) above, further comprising one or more of: a USB port, a battery power bank, and massage elements including a belt massage.
(10). The bag according to any one of (1) to (9) above, wherein the alarm system is adapted to be triggered remotely from the system, computer, or smart phone.
(11). The bag according to any one of (1) to (10) above, wherein components of the bag and the system, computer, or smart phone are configured for connection through Bluetooth technology.
(12). The bag according to any one of (1) to (11) above, which, when locked, may be opened by the owner only, through finger identification and/or voice identification.
(13). The bag according to any one of (1) to (12) above, which is registered on an online platform (for example Google™) and is operably connected thereto.
(14). The bag according to any one of (1) to (13) above, which is operably connected to the system, computer, or smart phone through applications installed thereon.
(15). The bag according to any one of (1) to (14) above, wherein the system, computer, or smart phone is a proprietary of the owner of the bag, a family member of the owner, a police service, and/or a call center.
(16). The bag according to (9) above, wherein, in use, the massage elements massage the shoulders and/or back of a user of the bag.
(17). Security system for a bag, comprising: a locking system comprising a voice identification system and/or a finger identification system; an alarm system comprising a first mode configured for speaking and a second mode configured for using a camera; and a positioning locator comprising a locator chip and/or a GPS tracking system, wherein locking system, the alarm system, and the positioning locator are configured remote operation from a system, computer, or smart phone.
(18). The system according to (17) above, wherein finger identification system is a one-, two-, three-, four-, or five-finger identification system.
(19). The system according to (17) or (18) above, wherein the camera is a live stream camera.
(20). The system according to any one of (17) to (19) above, wherein the system, computer, or smart phone is a proprietary of the owner of the bag, a family member of the owner, a police service, and/or a call center.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1: Bag according to the invention in open position showing the locking system.

FIG. 2: Bag according to the invention in closed position.

FIG. 3: Bag according to the invention showing the finger identification system.

FIG. 4: Bag according to the invention showing massage elements.

FIG. 5: Bag according to the invention showing massage elements including a belt massage.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments; and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The inventor has designed and constructed a bag which integrates a security system and other elements allowing for its efficient and convenient use. The bag according to the invention operates by wireless digital communication and provides confidence to the owner and/or user.

According to an aspect of the invention, the bag comprises one or more of: a locking system, a voice identification system, a finger identification system, a locator chip, an alarm system, a stream live camera, a GPS tracking system, push notifications, a USB port, a battery power bank, massage elements including a belt massage, and a Bluetooth system.

The bag according to the invention as described herein and illustrated in the accompanying drawings presents an improvement over the bags currently known in the art. As will be apparent from the description herein below, the bag according to the invention discourages someone intending to steal the bag and provides the user with some level of security and confidence. Also, if the bag is simply misplaced, it can be located quite easily.

Indeed, the owner or user of the bag can trigger the alarm system associated to bag, remotely, on a computer or a smartphone. The bag will then start ringing while in the hands of the person who stole the bag. A signal is automatically sent to family members, the police and/or any suitable call center. And with the alarm ringing continuously, this will scare off the thief who will drop off the bag.

In embodiments of the invention, the alarms system may comprise two modes. A first mode of the alarm system is triggered for example in a situation where the user of the bag is unable to speak. In this first mode, the alarm system is adapted to speak for the use and notify family members, the police and/or any relevant call center. In a second mode of the alarm system, the camera gets into operation and provides a live stream of the events occurring. In this second mode, the camera uses a motion detection algorithm and functions continuously 24 hours/7 days. As will be understood by a skilled person, the first and second modes of the alarm system may operate simultaneously or individually, as desired.

In embodiments of the invention wherein a camera is used as described above in the second mode of the alarm system, live streaming allows for the identification of any suspicious activities around the user of the bag, for example a suspicious person following the user of the bag. The camera is adapted to automatically pivot and change to night vision. All the movements around the user of the bag are thus recorded, at any time, while the user of the bag is standing, walking, or sitting. Emergencies services can be alerted if it is determined that the user of the bag is in any danger.

In embodiments of the invention, a digital fingerprint system is provided on an external part of the bag. A reading system is incorporated to the fingerprint system and is used to unlock or lock the bag by the owner. This is based on the recognition of the owner's digital imprint.

Thus, the bag according to the invention decreases the chances of the bag getting stolen, of objects getting lost, and helps protect the bag owner's privacy. The bag owner feels more comfortable knowing that he/she can leave the bag unattended at least for a short period of time; for example, a student leaving the classroom to use the bathroom. No one will be able to open the bag without his/her permission.

In embodiments of the invention, the bag is registered on a suitable online platform such as Google™ using particulars of the bag such as bar code, password, and the like. If the owner of the bag is unable to locate the bag, he/she can go to the online platform, enters the relevant information. The platform will indicate precisely where the bag is located and provide the address. The platform will also indicate whether the bag is indoor, outdoor, or inside a moving object such as a car, a bus, a train, a boat, or a plane. As indicated above, the owner of the bag can trigger the alarm system, remotely, on a computer or a smartphone. The bag will then start ringing and a signal is automatically sent to family members, the police, and/or any relevant call center.

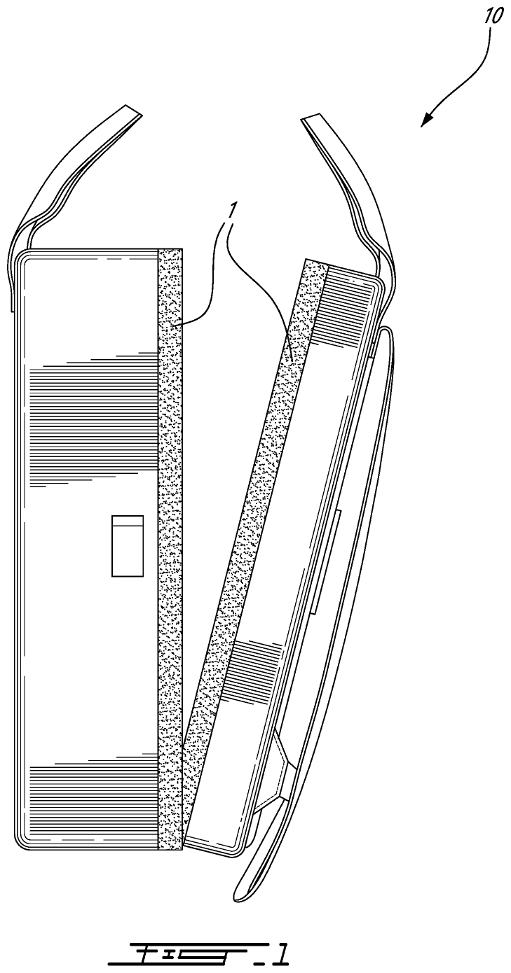

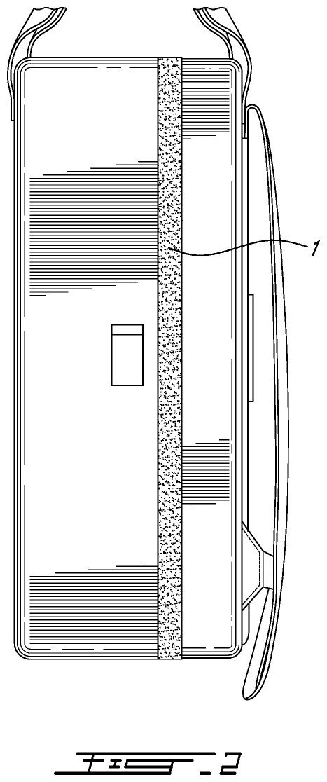

Referring to FIG. 1, the bag 10 in open position is shown. The associated locking system 1 is illustrated. A locator chip (not shown) allows the owner to locate the bag when it is missing. The bag in closed position is illustrated in FIG. 2. A voice identification (not shown) is associated to the bag allowing for the owner to open the bag by a vocal command.

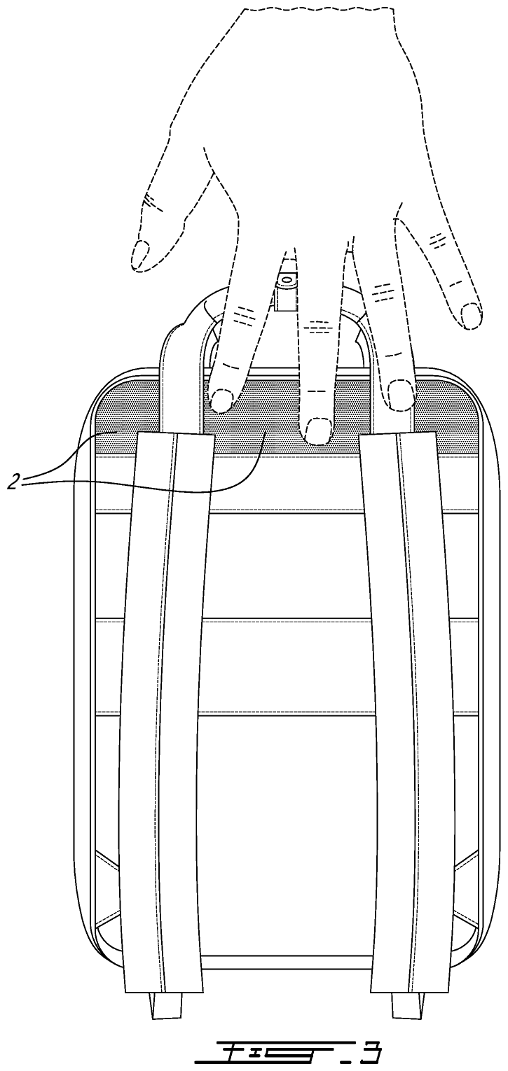

In embodiments of the invention, the bag comprises a finger identification system 2. This is illustrated in FIG. 3. In preferred embodiments of the invention, the finger identification system is a five-finger identification system. As will be understood by a skilled person, it may also a one-, two-, three-, or four-finger identification system. The bag opens when the owner touches the identification part with his/her finger(s).

In embodiments of the invention, the bag comprises a GPS tracking system. This allows for a real time localization of any movements of the bag.

In embodiments of the invention, the bag comprises a locater chip as indicated above. The locator chip may perform the following functions: connect to a smart phone App; trace the location of the bag; send messages to the owner, or police, or any other relevant entity; activate the alarm on the bag.

In embodiments of the invention, the bag comprises other elements that perform useful functions to the user of the bag. For example, the bag comprises a UBS port. A USB device will help, among others, in transferring data and all the recordings to a computer of a smart phone.

In embodiments of the invention, the bag comprises other elements useful to the user of the bag. For example, a battery power bank which allows the user to conveniently charge electronic devices while on the road. The battery power bank is provided inside the bag, for example is slim pocket attached to the bag. The battery power bank may weight for example about 116 g, may have a length of about 13 cm length and a width of about 6.5 cm, and may have a power between about 7,500-14,999 mAh.

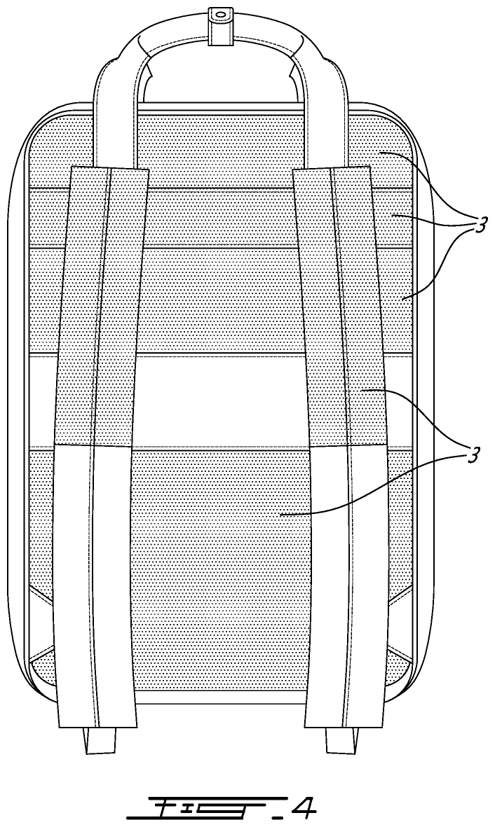

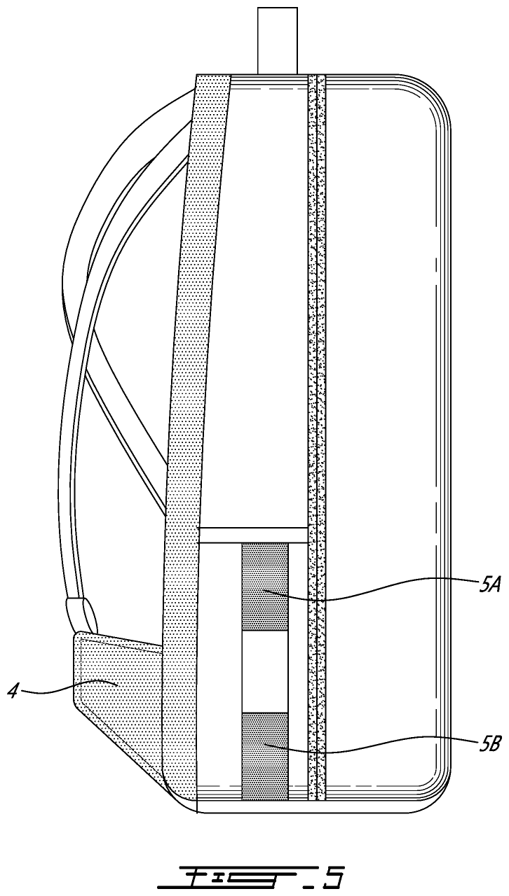

In embodiments of the invention, other elements useful for the wellbeing and comfort of the user of the bag may be associated to thereto. For example, as illustrated for example in FIG. 4 and FIG. 5, massage elements 3 including a massage belt 4 may be associated to the bag. Indeed, the user of the bag can massage his/her shoulders and back while carrying the bag. In preferred embodiments, multiple head gun tip massage elements are provided within the fabric at the back side of the bag, which exert pressure on the shoulders and back of the user. The massage elements can be adapted to rotate in a direction for a set time period (for example 22 minutes) then rotate in the opposite directed for another set time period. Movement of the massage elements may be slow and repetitive, with pressure, in order to lose tight muscles and increase blood flow in the body of the bag user. Movements may be controlled by the user on his/her smart phone or by buttons associated to the bag. Movements may also be controlled remotely.

In embodiments of the invention, electronic devices associated to the bag are connected through Bluetooth technology. This enhances the efficiency of the use of the features of the bag providing more security and confidence to the user.

FIG. 5 further illustrates the two modes of the alarm system as outlined above. The first mode 5A configured for speaking and the second mode 5B configured for using a camera. As will be understood by a skilled person, the alarm may comprise one mode, two modes, or more than two modes.

As will be understood by a skilled person, other variations and combinations may be made to the various embodiments of the invention as described herein above.

The scope of the claims should not be limited by the preferred embodiments set forth in the examples; but should be given the broadest interpretation consistent with the description as a whole.

1. A bag having a security system comprising a locking system, an alarm system, and a positioning locator, wherein the security system is configured for a remote operation from a system, computer, or smart phone.

2. The bag according to claim 1, wherein the locking system comprises a voice identification system and/or a finger identification system.

3. The bag according to claim 1, wherein the finger identification system is a one-, two-, three-, four-, or five-finger identification system.

4. The bag according to claim 1, wherein the alarm system comprises a first mode configured for speaking and a second mode configured for using a camera.

5. The bag according to claim 4, wherein the first and second modes of the alarm system are configured for operation simultaneously or separately.

6. The bag according to claim 4, wherein the camera is a live stream camera.

7. The bag according to claim 1, wherein the positioning locator comprises a locator chip and/or a GPS tracking system.

8. The bag according to claim 1, further comprising push notifications.

9. The bag according to claim 1, further comprising one or more of: a USB port, a battery power bank, and massage elements including a belt massage.

10. The bag according to claim 1, wherein the alarm system is adapted to be triggered remotely from the system, computer, or smart phone.

11. The bag according to claim 1, wherein components of the bag and the system, computer, or smart phone are configured for connection through Bluetooth technology.

12. The bag according to claim 1, which, when locked, may be opened by the owner only, through finger identification and/or voice identification.

13. The bag according to claim 1, which is registered on an online platform (for example Google™) and is operably connected thereto.

14. The bag according to claim 1, which is operably connected to the system, computer, or smart phone through applications installed thereon.

15. The bag according to claim 1, wherein the system, computer, or smart phone is a proprietary of the owner of the bag, a family member of the owner, a police service, and/or a call center.

16. The bag according to claim 9, wherein, in use, the massage elements massage the shoulders and/or back of a user of the bag.

17. Security system for a bag, comprising:
a locking system comprising a voice identification system and/or a finger identification system;
an alarm system comprising a first mode configured for speaking and a second mode configured for using a camera; and
a positioning locator comprising a locator chip and/or a GPS tracking system, wherein locking system, the alarm system, and the positioning locator are configured remote operation from a system, computer, or smart phone.

18. The system according to claim 17, wherein finger identification system is a one-, two-, three, four-, or five-finger identification system.

19. The system according to claim 17, wherein the camera is a live stream camera.

20. The system according to claim 17, wherein the system, computer, or smart phone is a proprietary of the owner of the bag, a family member of the owner, a police service, and/or a call center.
